(19) United States
(12) Patent Application Publication
(10) Pub. No.: US 2011/0004419 A1
(43) Pub. Date: Jan. 6, 2011

(54) APPARATUS, SYSTEM, AND METHOD OF DETERMINING APPARATUS STATE

(76) Inventors: Kohji Ue, Ebina (JP); Yasushi Nakazato, Tokyo (JP); Osamu Satoh, Sagamlhara (JP); Masahide Yamashita, Tokyo (JP); Jun Yamane, Yokohama (JP); Mikiko Imazeki, Ebina (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/818,564

(22) Filed: Jun. 18, 2010

(30) Foreign Application Priority Data
Jul. 1, 2009 (JP) 2009-157208

(51) Int. Cl. G06F 17/18; G06F 19/00

(52) U.S. Cl. 702/34; 702/181

(57) ABSTRACT

A state predicting apparatus collects internal information and usage information of an apparatus subjected for failure prediction determination, calculates a state index value using a regression model and the internal information of the apparatus, calculates a usage factor indicating a predicted remaining time period between a time when the state index value is calculated and a time when a failure is predicted to occur using the usage information of the apparatus, and calculates a failure risk based on the state index value and the usage factor.

### CROSS-REFERENCE TO RELATED APPLICATIONS

This patent application is based on and claims priority under 35 U.S.C. §119 to Japanese Patent Application No. 2009-157208, filed on Jul. 1, 2009, in the Japanese Patent Office, the entire disclosure of which is hereby incorporated herein by reference.

### FIELD OF THE INVENTION

The present invention generally relates to an apparatus state determining apparatus capable of determining a state of an apparatus, and more specifically to a system and method of predicting failure of the apparatus using the apparatus state determining apparatus.

### BACKGROUND

Failure prediction systems are available that predict a failure in an apparatus such as an image forming apparatus before such failure occurs. For example, Japanese Patent Application Publication No. 2008-258897 (JP-2008-258897-A) discloses a failure prediction system that calculates a failure prediction index indicating the probability of failure of the apparatus in the near future based on internal information of the apparatus, and determines whether the apparatus is most likely to fail based on the calculated failure prediction index. Since the probability for the apparatus to fail depends on environmental factors that influence operation of the apparatus, such as temperature and humidity, the failure prediction system selects a regression model to calculate the failure prediction index based on environmental information obtained from the apparatus to improve failure prediction accuracy.

Although the above-described system is able to improve failure prediction accuracy to a certain degree, there have been cases in which the apparatus fails even when the calculated failure prediction index indicates that the apparatus is not likely to fail, or cases in which the apparatus does not fail even when the calculated failure prediction index indicates that the apparatus is most likely to fail. Since the failure prediction index does not accurately indicate when the apparatus is most likely to fail, the failure prediction index has not been useful to service engineers who need to plan a schedule for maintaining the apparatus.

In view of the above, there is a need for a state determining system capable of providing a failure prediction index that actually indicates, with improved accuracy, when the apparatus is most likely to fail.

### SUMMARY

The inventors of the present invention have discovered that, the difference in a time period between a time when failure prediction is performed and a time when a failure actually occurs, which have been observed among a plurality of apparatuses having the same level of a failure prediction index, has a strong relationship with usage information of each apparatus that indicates the degree of usage of each apparatus by a user. In order to improve the accuracy in failure prediction, a failure prediction system uses computational formula that indicates the relationship between a failure prediction index and usage information. This improves the accuracy in predicting a time period between a time when failure prediction determination is conducted and a time when a failure actually occurs. More specifically, one aspect of the present invention is to provide an apparatus, method, and system of calculating a failure risk using a usage factor indicating a predicted remaining time period until a time at which a failure is predicted to occur in addition to the internal information of the apparatus, and determining whether the apparatus is in a state that is most likely to fail. Since the usage factor is additionally taken into account, the accuracy in predicting a failure in the apparatus improves.

Example embodiments of the present invention include an apparatus, method, system, computer program and product each capable of collecting internal information and usage information of an apparatus subjected for failure prediction determination, calculating a state index value using a regression model and the internal information of the apparatus, calculating a usage factor indicating a predicted remaining time period between a time when the state index value is calculated and a time when a failure is predicted to occur using the usage information of the apparatus, and calculating a failure risk based on the state index value and the usage factor.

In addition to the above-described example embodiments, the present invention may be practiced in various other ways, for example, as a computer program stored on a recording medium which causes a computer to perform a method of determining a state of an apparatus or a recording medium storing such computer program.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a failure prediction system including a failure prediction apparatus according to an example embodiment of the present invention;

FIG. 2 is a schematic block diagram illustrating a structure of the failure prediction apparatus of the failure prediction system of FIG. 1;

FIG. 3 is a schematic block diagram illustrating an image forming apparatus subjected for analysis by the failure prediction apparatus of FIG. 2;

FIG. 4 is a data sequence diagram illustrating operation of predicting a failure in the image forming apparatus of FIG. 3, performed by the failure prediction apparatus of FIG. 2, according to an example embodiment of the present invention;

FIG. 5 is a flowchart illustrating operation of generating a regression model used for failure prediction, performed by the failure prediction apparatus of FIG. 2, according to an example embodiment of the present invention; and

FIG. 6 is a flowchart illustrating operation of determining a failure prediction state, performed by the failure predication apparatus of FIG. 2, according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

For the descriptive purpose, the following illustrates an example case of determining a state of an image forming apparatus such as a copier, printer, or facsimile to predict whether the image forming apparatus is most likely to fail in the near future. In this example, the image forming apparatus is implemented as a copier that forms a toner image using electrophotographic method. Alternatively, any apparatus may be subjected for such failure prediction determination as long as such prediction is desirable. The apparatus subjected for failure prediction does not have to be so much affected by environmental factors. In the following examples, the apparatus subjected for failure prediction determination may be referred to as the copier 10 or the apparatus.

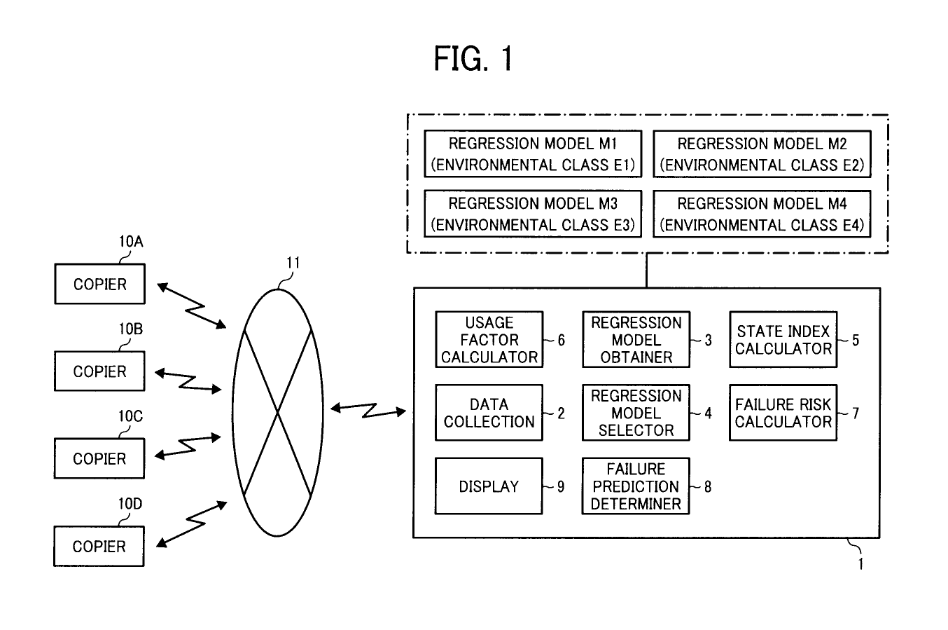

FIG. 1 illustrates a failure prediction system according to an example embodiment of the present invention. The failure prediction system of FIG. 1 includes a plurality of copies such as a copier 10A, 10B, 10C, and 10D (collectively referred to as the “copier 10”), and a failure prediction apparatus 1 connected to the copier 10 through a communication network 11. The failure prediction apparatus 1 functions as a state determining apparatus capable of determining a state of an apparatus subjected for failure prediction determination such as the copier 10. Further, in this example, it is assumed that the failure prediction apparatus 1 is provided at a maintenance center where each one of the copiers 10A, 10B, 10C, and 10D is managed through the communication network 1. In this example, the copiers 10A, 10B, 10C, and 10D are provided at one or more locations remote from the maintenance center.

The failure prediction apparatus 1 includes a data collection 2, a regression model obtainer 3, a regression model selector 4, a state index calculator 5, a usage factor calculator 6, a failure risk calculator 7, a failure prediction determiner 8, and a display 9. The failure prediction system of FIG. 1 further includes a computation formula data storage, which may be implemented by any desired memory or storage device.

The data collection 2 collects internal information of the copier 10 together with environmental information and usage information. The regression model obtainer 3, which may be alternatively referred to as the regression model acquisition unit 3, obtains a plurality of regression models. In this example, the plurality of regression models are classified into a regression model M1, M2, M3, and M4, respectively corresponding to environmental classes E1, E2, E3, and E4. The regression model selector 4 selects one of the plurality of regression models obtained by the regression model obtainer 3 based on the environmental information collected by the data collection 2. The state index calculator 5 calculates a state index value using the internal information of the copier 10 collected by the data collection 2 and the regression model selected by the regression model selector 4. The usage factor calculator 6 determines a usage state class using the usage information collected by the data collection 2, and calculates a usage factor using computation formula data stored in the computation formula data storage based on the determined usage state class. In this example, the usage factor indicates a predicted remaining time period between a time when the state index value is calculated by the state index calculator 5 and a time when a failure is predicted to occur. The failure risk calculator 7 calculates a failure risk using the state index value calculated by the state index calculator 5 and the usage factor calculated by the usage factor calculator 6. The failure prediction determiner 8 determines a state of the copier 10 based on the failure risk calculated by the failure risk calculator 7.

The failure prediction system of FIG. 1 determines whether the copier 10 is in a failure risk state indicating whether a failure is most likely to occur in the near future, and to determine whether to dispatch a service engineer to check the copier 10 such that a failure of the copier 10 is prevented before such failure occurs.

In this example, the internal information of the copier 10, which is to be used for calculating the state index value indicating a state of the copier 10, includes information regarding one type of factor that is most likely to fail. In order to improve the accuracy in predicting more than one type of failure, the internal information preferably includes information regarding a plurality of types of factor that leads to a failure. While the internal information regarding one of the plurality of types of factor may include only one piece of information, the internal information regarding one of the plurality of types of factor preferably includes more than one piece of information in order to improve the accuracy in predicting a failure attributable to the internal information regarding one of the plurality of types.

In this example, the environmental information may include at least one of temperature information and humidity information, or any other environmental information regarding the internal environment of the copier 10 or the environment surrounding the copier 10 that may be attributable to a failure.

In this example, the usage information may include any one of total image number information, unit usage information, toner consumption information, etc. The total image number information indicates an accumulated number of images that has been formed, which is obtainable by a total counter that counts a number of images that has been formed from the time when the copier 10 is installed. The unit usage information indicates the degree of usage of an image forming unit, which is obtainable by a unit counter that obtains the degree of usage of the image forming unit from the time when the copier 10 is installed or from the time when the image forming unit is replaced. The toner consumption information indicates the amount of toner that is consumed, which is obtainable by a toner level detector that obtains the level of toner that remains in a toner container from the time when the toner container is installed or replaced.

In this example, the information collection 2 receives information such as the internal information, environmental information, and usage information from the copier 10 through the communication network 11 at a predetermined timing. Alternatively, the information collection 2 may obtain such information including the internal information, environmental information, and usage information regarding the copier 10 by reading such information out from a removable recording medium. The information collection 2 may be designed to determine which type of information regarding the copier 10 should be collected in what manner based on the purpose of data collection. For example, in order to efficiently collect various types of data, the information collector 2 is designed to periodically collect the internal information together with the environmental information and the usage information from the copier 10. In order to improve the accuracy in predicting a failure risk state of the copier 10 while taking into account the temporal change in each copier 10, the information collection 2 is designed to collect the internal information, the environmental information, and the usage information together with information indicating the date and the time at which each type of information is collected, from the copier 10.

The regression model obtainer 3 obtains a plurality of regression models M1, M2, M3, and M4, each of which is used to calculate a state index value and respectively correspond to a plurality of environmental classes E1, E2, E3, and E4. For example, any one of the regression models M1, M2, M3, and M4 may be generated using internal information obtained from an apparatus subjected for analysis when the apparatus causes a failure. When such internal information of the apparatus subjected for analysis is not available, internal information of any other apparatus of the same type or similar type as the apparatus subjected for analysis may be obtained. Further, the state index value may be any type of index value that indicates the probability of the apparatus failing in the near future. In this example, the regression model obtainer 3 stores the plurality of regression models M1, M2, M3, and M4 once the regression models are generated. With the use of the plurality of regression models M1, M2, M3, and M4, the computational error attributable to environmental information may be suppressed when compared with the case of generating a regression model based on environmental information that is obtained from the apparatus subjected for analysis each time a request for failure prediction is received.

The regression model obtainer 3 may obtain the plurality of regression models M1, M2, M3, and M4 using any known regression analysis, for example, using logistics regression analysis. For example, in order to easily generate the regression models M1, M2, M3, and M4, the regression models may be generated based on the internal information of the copier 10 when the copier 10 causes a failure and the internal information of the copier 10 when the copier 10 is repaired after the failure. In another example, in order to accurately reflect the influence caused by seasonal change, the regression model obtainer 3 may be designed to update the regression models M1, M2, M3, and M4 at a predetermined timing. For example, the regression models may be updated periodically or at any other timing specified by a service engineer or any other person at the maintenance center. Further, in order to improve the accuracy in failure prediction, the regression models M1, M2, M3, and M4 respectively corresponding to the environmental classes E1, E2, E3, and E4 may be further classified into a plurality of regression models based on the cause of a failure.

The regression model selector 4 selects at least one of the regression models M1, M2, M3, and M4 respectively corresponding to the environmental classes E1, E2, E3, and E4, based on the environmental information collected from the copier 10.

The state index calculator 5 calculates a state index value using the regression model selected by the regression model selector 4 and the internal information of the copier 10 collected by the information collection 2.

In this example, the regression model selector 4 may select at least one of the regression models M1, M2, M3, and M4 at any time before the state index calculator 5 completes calculation of the state index value. For example, selection of the regression model may be performed concurrently with calculation of the state index value.

The usage factor calculator 6 is provided with the computer formula data storage, which stores computation formula data used for calculating the usage factor from the usage information. The usage factor indicates a predicted remaining time period between a time when the state index value is calculated by the state index calculator 5 and a time when a failure is predicted to occur. The usage factor calculator 6 determines a usage state class using the usage information collected by the data collection 2, and calculates a usage factor using computation formula data stored in the computation formula data storage that is selected based on the determined usage state class.

In this example, the usage factor is calculated as follows, but calculation may be performed in various other ways.

First, the usage factor calculator 6 analyzes the internal information previously obtained for a plurality of apparatuses of the same or similar type to obtain information identifying at least two apparatuses that have been assigned with the same state index value at a certain point of time but have different remaining time periods between a time at which the state index value is calculated and a time at which a failure occurs. When an inverse number of the remaining time period between the time at which the state index value is obtained and the time at which a failure accentually occurs is expressed as Y, and the index value that influences the apparatus state until the failure occurs is expressed as Xi, Y is obtained as a linear sum of Xi. Accordingly, a coefficient is calculated using the least square method. In this example, the index value Xi is an increased value per unit time regarding usage information indicating the usage of the apparatus by a user. For example, the usage information may be obtained based on the counter value of the total counter or unit counter, or the toner consumption level. In this example, the unit time may be set to any desired time, for example, one month such that the index value Xi is obtained once per month. The conversion formula that is generated is stored in the computation formula data storage as the computation formula data. The usage factor calculator 6 calculates the usage factor Y of the copier 10 by inputting the usage information Xi of the copier 10 obtained from the copier 10 into the computation formula.

The failure risk calculator 7 calculates a failure risk using the state index value calculated by the state index calculator 5 and the usage factor calculated by the usage factor calculator 6. In this example, the failure risk calculator 7 obtains the failure risk by multiplying the state index value calculated by the state index calculator 5 with the usage factor Y obtained by the usage factor calculator 6. Alternatively, the failure risk may be calculated in various other ways based on the state index value and the usage factor.

The failure prediction determiner 8 determines the state of the copier 10 based on the failure risk calculated by the failure risk calculator 7. In this example, any threshold value or any method of predicting a failure may be selected to determine the state of the copier 10. In this example, the failure risk to be used for determining the state of the copier 10 is calculated based on the usage information indicating the degree of usage of the copier 10 by the user. Accordingly, the failure risk used for determining a state of the copier 10 reflects the degree of usage of the copier 10 by the user such that the failure prediction apparatus 1 is able to predict a failure with improved accuracy.

For example, the failure prediction determiner 8 classifies a plurality of failure risk values previously calculated by the failure risk calculator 7 into a plurality of classes using the threshold, and determines the state of the apparatus by identifying one of the classes to which the failure risk value of the apparatus belongs. In order to modify criteria for determining whether the apparatus has a failure risk state that is most likely to fail, a value of the threshold used for classifying the failure risk values may be changed. Assuming that the failure risk is used to determine whether to dispatch the service engineer to a location at which the copier 10 is located, the failure risk determiner 8 may be designed to generate a determination result indicating that the service engineer should be dispatched when the failure risk value just calculated exceeds a predetermined threshold value. The threshold value is previously set such as to indicate the value of a failure risk that is generated when the apparatus should be repaired immediately. Further, in order to improve the accuracy in failure prediction determination, information regarding the state of the apparatus determined by the failure prediction determiner 8 may be displayed on the display unit 9.

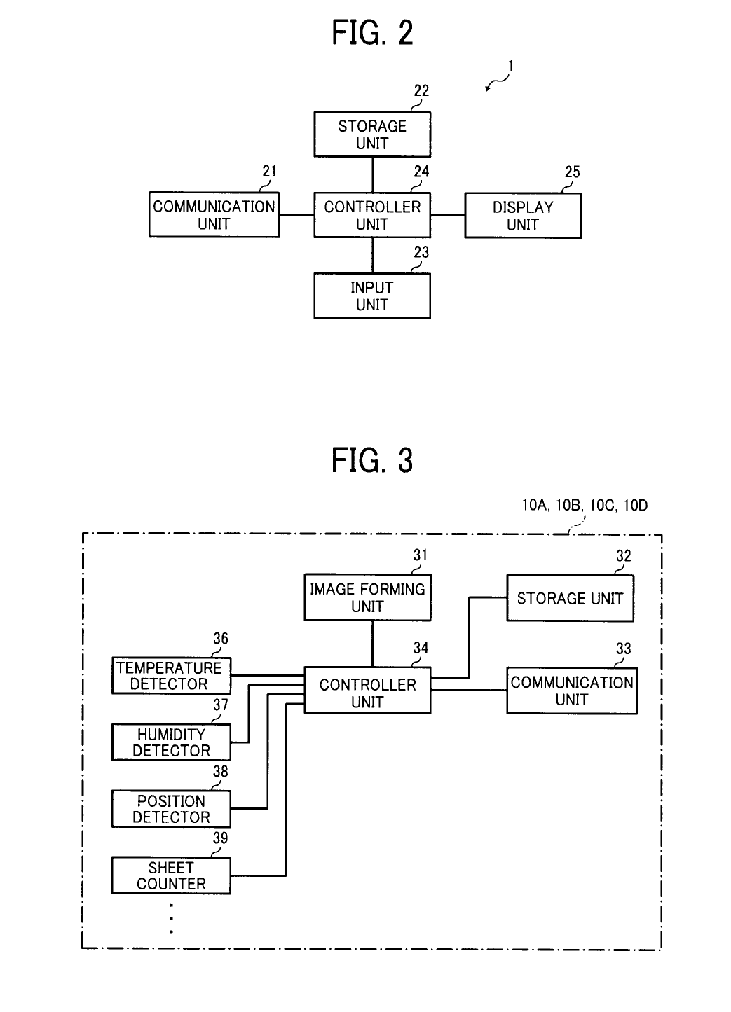

FIG. 2 illustrates a schematic structure of the failure prediction apparatus 1 of the failure prediction system of FIG. 1. The failure prediction apparatus 1 includes a communication unit 21, a storage unit 22, an input unit 23, a controller unit 24, and a display unit 25. The failure prediction apparatus 1 may be implemented by any desired information processing apparatus capable of communicating with the copier 10 through the communication network 11.

The communication unit 21 receives various information such as the internal information, the environmental information, and the usage information, from the copier 10. The storage unit 22 stores data such as a plurality of regression models that may be used to determine whether the copier 10 is in a failure risk state that is most likely to fail using the internal information received by the communication unit 21, and/or computation formula data that is used to calculate a usage factor using the usage information received by the communication unit 21. The input unit 23 allows a user, such as the service engineer, to input various information. The controller unit 24 controls operation of the failure prediction apparatus 1 such as operation of determining a state of the copier 10 in response to a request received from the input unit 23. The display unit 25 displays various information such as a processing result of the controller unit 24 to a user such as the service engineer.

FIG. 3 illustrates a schematic structure of the copier 10 of the failure prediction system of FIG. 1. The copier 10 forms an image on a recording sheet using electrophotographic method. The copier 10 includes an image forming unit 31, a storage unit 32, a communication unit 33, a controller unit 34, and various detectors including a temperature detector 36, a humidity detector 37, a position detector 38, and a sheet counter 39.

The image forming unit 31 forms an image on a recording sheet. The storage unit 32 stores various programs such as image forming control program. The communication unit 33 allows the copier 10 to communicate with the failure prediction apparatus 1. The controller unit 34 controls the storage unit 32 and the communication unit 33. The temperature detector 36 detects the internal temperature detected inside the copier 10 as well as the ambient temperature detected at an environment surrounding the copier 10. The humidity detector 37 detects the internal humidity detected inside the copier 10 and the ambient humidity detected at an environment surrounding the copier 10. The position detector 38 is provided along a sheet transfer path to detect the position of the recording sheet. The detected result of the position detector 38 may be used for controlling transfer of a recording sheet or detecting whether the recording sheet is jammed. The sheet counter 39 counts a number of recording sheets to function as a total counter that counts a number of images that has been formed by the copier 10. The controller unit 34 performs various operation according to a control program stored in the storage unit 32. For example, the controller unit 34 causes the image forming unit 31 to form an image according to the image forming control program stored in the storage unit 32. The controller unit 34 stores various information regarding the copier 10 such as the internal information, the usage information, and the environmental information, in the storage unit 32. The controller unit 34 sends various information regarding the copier 10 to the failure prediction apparatus 1 through the communication unit 33.

Examples of information regarding the copier 10, which may be referred to as management information of the copier 10, include internal information regarding the copier 10, environmental information such as temperature data obtained by the temperature detector 36 and humidity data obtained by the humidity data 37, the machine ID of the copier 10, and/or date/time information indicating the date and/or time at which such information regarding the copier 10 is collected. Additionally, usage information such as total image number information obtained by the sheet counter 39 may be obtained as management information.

Examples of internal information of the copier 10 includes information regarding a warning signal or a fail signal that is automatically sent by the copier 10 based on its operation state, and information regarding a parameter value or an observed value used for controlling various operations. Such internal information may be stored in the storage unit 32, which functions as a non-volatile memory. The examples of fail signal include a system fail signal, local fail signal, recording sheet jam fail signal, and original sheet fail signal. For each type of fail signals, about 20 to 30 specific fail signals may be generated. Such fail signal may be detected by a detector such as the position detector 38 provided in the copier 10 or a program stored in the storage unit 32 of the copier 10. Once detected, information regarding a fail signal such as the contents of a fail, the number of fails, the log of fails, etc. may be stored in the copier 10 together with a count value of the recording sheets when the fail signal is detected. Such information regarding a fail is constantly updated such that information regarding a predetermined number of most recently occurred fail signals is maintained. For example, the number of fail signals to be accumulated may be set to be 20 or lower for each type of fail signals.

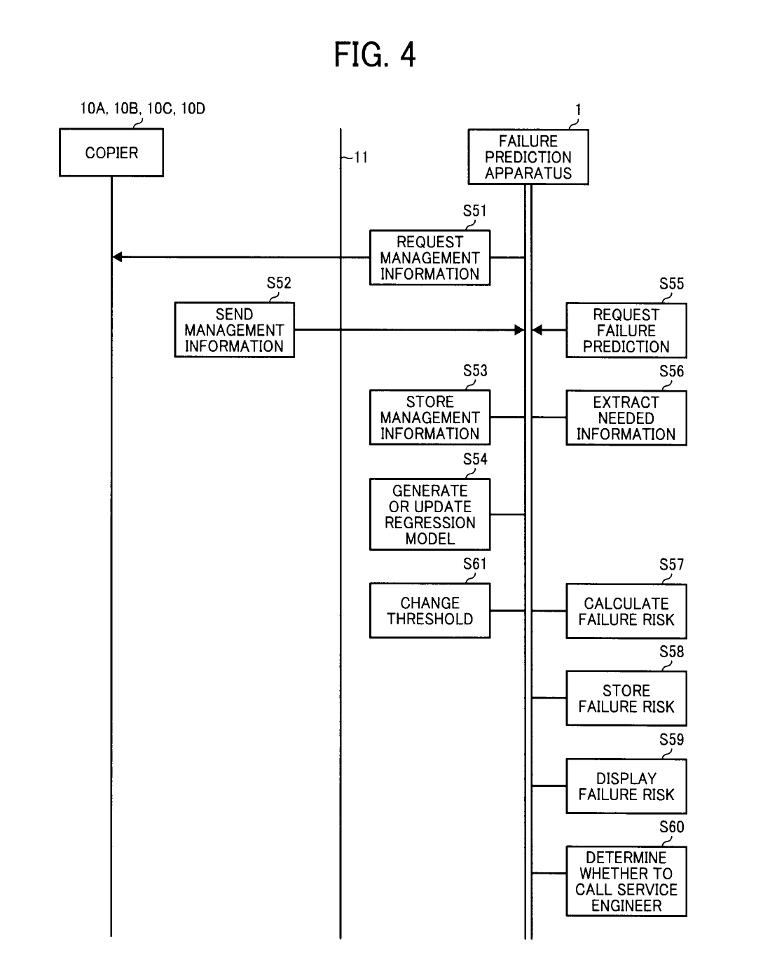

FIG. 4 illustrates a sequence flow diagram illustrating operation of predicting a failure risk state of the copier 10, according to an example embodiment of the present invention.

At S51, the failure prediction apparatus 1 periodically sends a management information request signal which requests the copier 10 to send management information.

At S52, the copier 10 sends the management information to the failure prediction apparatus 1 in response to the management information request signal.

At S53, the failure prediction apparatus 1 stores the management information in the storage unit 22.

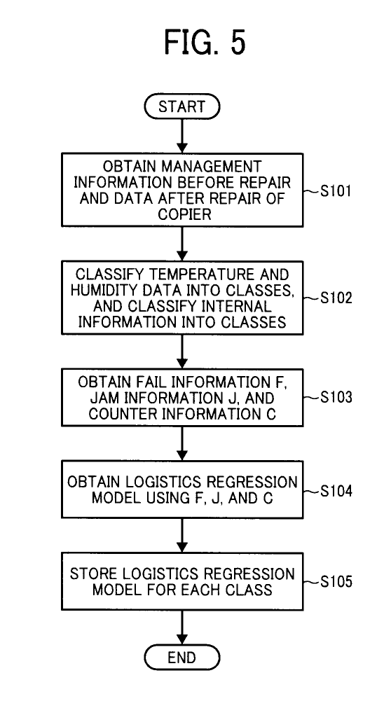

At S54, when the failure prediction apparatus 1 predicts a state of the copier 10 for the first time, the failure prediction apparatus 1 generates one or more regression models in a manner described below referring to FIG. 5. Alternatively, at S54, the failure prediction apparatus 1 updates the regression model based on the management information received from the copier 10.

Referring to FIG. 5, operation of generating a regression model is explained.

At S101, the failure prediction apparatus 1 obtains two types of internal information including one type obtained when the copier 10 is in a failure state and the other type obtained when the copier 10 is in a normal state.

For example, assuming that a user of the copier 10A requests a service engineer at the maintenance center to repair the copier 10A, the failure prediction apparatus 1 at the maintenance center collects the internal information of the copier 10A together with the temperature data and the humidity data at a time when such request is received, as the failure internal information which is the internal information obtained from the copier 10A when the copier 10A is in the failure state. After the copier 10A is repaired by the service engineer, the failure prediction apparatus 1 collects the internal information of the copier 10A, 10B, 10C, and 10D, each of which operates normally without any failure, together with the temperature data and the humidity data, as the normal internal information which is the internal information obtained from the copier 10 when the copier 10 is in the normal state. At this time, it is preferable to collect the internal information, the temperature data, and the humidity data from a plurality of numbers of copiers.

At S102, two types of internal information obtained at S101 are classified. The temperature data usually ranges between 20 degree Celsius and 65 degree Celsius. The humidity data usually ranges between 124 relative humidity value to 135 relative humidity value. In this example, the temperature data values and the humidity data values are respectively classified into two classes, resulting in four different environmental classes of E1, E2, E3, and E4 each having a different range of temperature data values and humidity data values. Using the failure internal information and the normal internal information, which are classified into four environmental classes E1 to E4, the failure prediction apparatus 1 generates four regression models that respectively correspond to environmental classes E1 to E4.

At S103, from the internal information, fail information, jam information, and counter information are respectively obtained. At S104, the regression model is obtained using the fail information, jam information, and counter information. For example, as illustrated below, the regression model D using logistics regression analysis may be generated.

At S105, the regression model that is generated is stored in the storage unit 22 in association with an identification number that is uniquely assigned to the regression model.

For the descriptive purpose, the following regression model D is referred to as the formula 1.

D=1/1+exp(K1*F+K2*J+K3*C), wherein D indicates a state index value, K1, K2, and K3 respectively indicate regression coefficients, F indicates an explanatory variable of fail information, J indicates an explanatory variable of jam information, and C indicates the difference between a count value of the sheet counter 39 obtained when the failure occurs and a count value of the sheet counter 39 that is currently obtained.

The explanatory variable of fail information F is calculated using the following formula 2.

F=IOT_LogicFail+ESS_FanFail+SoftFail+SensorC_Fail+USB_Open_Fail+CommunicationFail, wherein IOT_LogicFail indicates a failure detected at an image output unit, ESS_FanFail indicates a failure detected at a fan of an image signal generator, SoftFail indicates a failure related to software, SensorC_Fail indicates a failure related to a sensor, USB_Open_Fail indicates a failure related to USB cable connection, and CommunicationFail indicates a failure in communication.

The explanatory variable of jam information J is calculated using the following formula 3.

J=Fuser_Jam+Regi_Jam+SoftFail+FeedOut_Jam+Exit_Jam+TakeAway_Jam, wherein Fuser_Jam indicates jam detected at a fuser of the image forming unit 31, Regi_Jam indicates jam detected at a registration roller pair, FeedOut_Jam indicates jam detected at a sheet feeding unit, Exit_Jam indicates jam detected at a discharge roller pair, and TakeAway_Jam indicates jam detected at a transfer roller pair.

In this example, one regression model is used for each one of the environmental classes E1 to E4. Alternatively, in order to improve the accuracy in failure prediction determination, each one of the environmental classes E1 to E4 may be further classified into a plurality of categories based on the cause that leads to a failure. The regression model used for calculating the state index value D may be then assigned to each one of the categories of the environmental class. As described above, the regression model used for calculating the state index value D is generated based on the internal information of the copier 10 that has generated a failure. In such case, since information regarding the failure such as a specific portion of the copier 10 causing the failure or the cause of the failure is known, the causes of the failure may be categorized into, for example, the sheet feeding trouble such as the jam trouble, the image quality trouble, and the mechanical trouble. The regression model may be generated for each one of the categories of trouble based on the internal information of the copier 10.

For example, in case of sheet feeding trouble, a regression model used for calculating the state index value D1 that reflects the sheet feeding trouble is generated. For example, the internal information used for generating the state index value D1 for the sheet feeding trouble includes information regarding the recording sheet jam fail, the original sheet jam fail, a distance between two succeeding sheets when the jam fail occurs, the local fail which is a fail regarding the position detector that detects the position of the recording sheet, the limit of a consumable supply, etc. In this example, the limit of the consumable supply is a value obtained by dividing a current number of usage of a specific device relating to sheet feeding by a limited number of usage of the specific device. The specific device relating to sheet feeding may be any desired device that is consumed or used as sheet transfer operation is performed such as a roller that feeds a recording sheet, solenoid, or motor, in case of sheet feeding trouble. The regression model of the state index value D1 for the sheet feeding trouble may be expressed as follows:

D1=1/(1+exp(−X)), wherein X=A1*(total number of recording sheet jam fails)+B1*(total number of original sheet jam fails)+C1*(average number of feeds during a time period between two succeeding fails)+D1*(total number of feeds)+E1*(limit of consumable supply).

In the above-described regression model, coefficients A1 to E1 correspond to K1 to K3 of the formula 1, and respectively defined based on the internal information of the apparatus that has caused a failure. Based on the internal information of the apparatus before the service engineer fixes the sheet feeding trouble and the internal information of the apparatus after the service engineer fixes the sheet feeding trouble, the regression model D1 is set to 1 to reflect the internal information before maintenance and the regression model D1 is set to 0 to reflect the internal information after maintenance to obtain coefficients A1 to E1. This method is known as logistics regression analysis.

The regression model D2 of the state index value for the image quality trouble may be generated based on the internal information that is categorized based on the image quality. The regression model D2 of the state index value for the image quality trouble may be expressed as follows:

D2=1/(1+exp(−Y)), wherein Y=A2*(total number of system fails)+B2*(total number of local fails)+C2*(measured value of sensor relating to image quality)+D2*(average number of feeds during a time period between two succeeding fails)+E2*(limit of consumable supply).

In this example, the limit of the consumable supply is a value obtained by dividing a current number of usage of a specific device relating to image quality by a limited number of usage of the specific device. The specific device relating to image quality may be any device that is consumed or used that relates to image quality such as a photoconductive drum or a developer. In the above-described regression model, coefficients A2 to E2 correspond to K1 to K3 of the formula 1, and respectively defined based on the internal information of the apparatus that has caused a failure. More specifically, based on the internal information of the apparatus before the service engineer fixes the image quality trouble and the internal information of the apparatus after the service engineer fixes the image quality trouble, the coefficients A2 to E2 are determined using the logistics regression analysis. When there is not enough internal information of the apparatus that indicates a previously caused failure, the coefficients may not be accurately obtained. Further, at the time of installing a copier having a new type, such internal information of the apparatus that indicates a previously caused failure may not be available. In either case, the internal information regarding the other type of apparatus may be used to define coefficients.

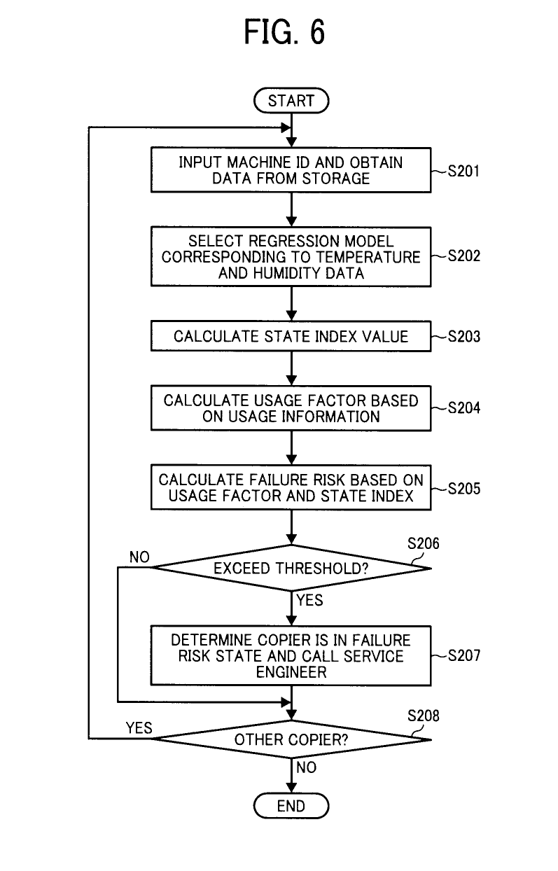

Referring back to FIG. 4, operation of determining whether the copier 10 is in a failure risk state indicating that the copier 10 is most likely to fail in the near future is explained. The operation of FIG. 6 is performed by the controller unit 24 of the failure prediction apparatus 1.

At S55, the failure prediction apparatus 1 receives a request for determining whether a specific copier 10 is in a failure risk state that is most likely to fail, for example, through the input unit 23. For example, the service engineer inputs identification information such as a machine ID of the copier 10 subjected for processing, and the date and/or time when data is collected, through the input unit 23. When such request is received, the controller unit 24 of the failure prediction apparatus 1 starts failure prediction determination. Alternatively, such request may be received through the communication unit 21.

At S56, the controller unit 24 obtains management information including the internal information, the environmental information such as the temperature data and humidity data, and the usage information, which respectively correspond to the identified machine ID from the storage unit 22.

At S57, the controller unit 24 selects one of the plurality of regression models based on environmental information such as the temperature and humidity data, and calculates a state index value D by inputting the internal information obtained at S56 to the selected regression model. The controller unit 24 calculates a usage factor based on the usage information. The controller unit 24 calculates a failure risk by multiplying the usage factor with the calculated state index value D.

At S58, the controller unit 24 stores the failure risk in the storage unit 22 in association with the machine ID, the date and/or time at which the data is collected, and the identification number that is uniquely assigned to the selected regression model.

At S59, the controller unit 24 displays the failure risk, the machine ID, and the date and/or time at which the data is collected on the display unit 25.

When the failure risk has been calculated using the machine ID of the copier 10 subjected for analysis and the date and/or time at which data is collected, and stored in the storage unit 22, the controller unit 24 may read the failure risk out from the storage unit 22, and displays the failure risk together with the machine ID and the date and/or time at which data is collected on the display unit 25.

In order to display a log of previously generated failure risks in the form of a graph, the user at the maintenance center may specify the machine ID and/or a range of data collection date through the input unit 23. In response to input information, the controller unit 24 automatically calculates a failure risk as described above, and displays the graph showing a history or a log of failure risk values on the display unit 25. For example, when the regression model of the state index value D is assigned for each category that is defined based on the cause of failure, the user is able to analyze the failure risk by failure type. When the failure risk of the sheet feeding trouble is greater than the failure risk of the image quality trouble, the user at the maintenance center is able to determine that the failure risk is high for the sheet feeding trouble to obtain the failure risk. Such failure risk may be used as a criteria for determining whether to dispatch the service engineer at the time when the internal information is received.

In this example, the failure risk is displayed as a probability value ranged between 0 and 1. Based on this failure risk value, the failure prediction apparatus 1 determines a failure risk state of the copier 10 which indicates the probability for the copier 10 to fail in the near future. For example, when the failure risk is less than a predetermined threshold of 0.5, the failure prediction apparatus 1 determines that it is not necessary to dispatch the service engineer. For example, when the failure risk falls in a range between 0.5 and 0.7, the failure prediction apparatus 1 determines that it is not necessary to dispatch the service engineer but continues to monitor the copier 10. When the failure risk exceeds the threshold value of 0.7, the failure prediction apparatus 1 determines that the copier 10 is most likely to fail in the near future, and determines to dispatch the service engineer no matter whether the user of the copier 10 calls for the service engineer. At S61, the threshold that is used for determining whether to dispatch the service engineer, such as the value of 0.7, may be changed, for example, according to a different type of the copier 10.

In this example, the user, such as the user at the maintenance center, may request the failure prediction apparatus 1 to perform failure prediction determination for more than one apparatus.

The storage unit 22 of the failure prediction apparatus 1 stores data that associates the code number assigned to each service engineer and the machine ID. When the service engineer inputs a specific code assigned to the service engineer through the input unit 23, the failure prediction apparatus 1 causes the display unit 25 to display a list of machine IDs that are respectively assigned to the copiers to be managed by the service engineer, together with the failure risks respectively calculated for the copiers. With this list, the service engineer is able to find out which one of the copiers needs maintenance. Further, the storage unit 22 of the failure prediction apparatus 1 stores data that associates a regional code and the machine ID. When a specific regional code assigned to a specific region at which one or more copiers are located is input through the input unit 23, the failure prediction apparatus 1 causes the display unit 25 to display a list of machine IDs that are located in the specific region identified by the specific regional code, together with the failure risks respectively calculated for the copiers. With this list, the service engineer is able to find out which region has a large number of copiers that need maintenance.

The regression model may be updated at any desired time. Since a number of fails caused in the copier 10 differs based on various conditions such as a condition of usage and a condition of environment, the regression model used for calculating the state index value D is periodically updated. For example, it is known that a number of jam fails tends to increase in winter due to humidity, at least in Japan, the regression model may be designed to be changed to reflect seasonal changes at a predetermined timing either periodically (such as for every one month) or according to a user preference. In alternative to updating the regression model, a threshold value may be changed to reflect the change in number of fails.

In the above-described example, the failure prediction apparatus 1 receives management information directly from the copier 10. Alternatively, the failure prediction apparatus 1 may obtain management information from a portable information processing apparatus through the communication network 11. The examples of the portable information processing apparatus include a note-book personal computer, personal digital assistant (PDA), portable phone, etc., which may be managed by the service engineer. In such case, the service engineer accesses the failure prediction apparatus 1 by inputting the code assigned to the service engineer, and remotely instructs the failure prediction apparatus 1 to perform failure prediction determination.

In the above-described example, the regression model used for calculating the state index value D is selected from a plurality of regression models M1, M2, M3, and M4 using the environmental information. Alternatively, the regression model to be used for calculating the state index value D may be previously set. In such case, selection process is not performed.

Referring to FIG. 6, operation of determining whether to dispatch a service engineer is explained.

At S201, the failure prediction apparatus 1 obtains management information from the storage unit 22 subjected for analysis. For example, the failure prediction apparatus 1 may receive information regarding a machine ID subjected for analysis, and obtains management information regarding the apparatus identified by the machine ID from the storage unit 22.

At S202, the failure prediction apparatus 1 selects one of a plurality of regression models stored in the storage unit 22 based on the environmental information obtained at S201.

At S203, the failure prediction apparatus 1 calculates a state index value of the apparatus subjected for analysis using the regression model selected at S202 and the management information such as the internal information obtained at S201.]

At S204, the failure prediction apparatus 1 calculates a usage factor using the usage information regarding the apparatus subjected for analysis obtained at S201.

At S205, the failure prediction apparatus 1 calculates a failure risk using the state index value and the usage factor.

At S206, the failure prediction apparatus 1 determines whether the failure risk value obtained at S205 exceeds a threshold value that is previously set. When it is determined that the failure risk value exceeds the threshold (“YES” at S206), the operation proceeds to S207. When it is determined that the failure risk value does not exceed the threshold (“NO” at S206), the operation proceeds to S208.

At S207, the failure prediction apparatus 1 determines that the apparatus subjected for analysis is in a failure risk state indicating that it is most likely to fail in the near feature based on the failure risk to generate a determination result.

At S208, the failure prediction apparatus 1 determines whether any other apparatus should be analyzed for failure prediction. When it is determined that there is any other apparatus subjected for analysis (“YES” at S208), the operation returns to S201 to perform the above-described steps with respect to the other apparatus. When it is determined that there is no other apparatus subjected for analysis (“NO” at S208), the operation ends.

The failure prediction system includes the failure prediction apparatus 1 and an apparatus subjected for analysis such as the copier 10, which are connected through the communication network 11. The failure prediction apparatus 1 determines a state of the copier 10 by calculating the state index value D based on the internal information of the copier 10. The failure prediction apparatus 1 includes an information collection 2 that collects the internal information of the copier 10 together with the usage information of the copier 10, a regression model obtainer 3 that obtains one or more regression models, a state index calculator 5 that calculates a state index value using the regression model obtained by the regression model obtainer 3 and the internal information of the copier 10 collected by the information collection 2, a formula data storage that stores computation formula data used for calculating a usage factor indicating a predicted remaining time period between a time when the state index value is calculated and a time when a failure is predicted to occur, a usage factor calculator 6 that calculates the usage factor using the usage information collected by the information collector 2 and the computation formula data stored in the formula data storage, a failure risk calculator 7 that calculates a failure risk based on the state index value calculated by the state index calculator 5 and the usage factor calculated by the usage factor calculator 6, and a failure prediction determiner 8 that determines whether the copier 10 is most likely to fail based on the failure risk calculated by the failure risk calculator 7 to generate a determination result.

The failure prediction system calculates a failure risk based on the usage factor indicating a predicted remaining time period between a time when the state index value is calculated by the state index calculator 5 and a time when a failure is most likely occur. Since the usage factor is taken into account for failure risk calculation, the failure risk value indicates a time when a failure actually occurs with improved accuracy.

Further, the information collection 2 collects environmental information such as temperature data and humidity data together with the internal information of the copier 10 and the usage information of the copier 10. The regression model obtainer 3 obtains a plurality of regression models that are respectively categorized based on environmental information. The regression model selector 4 selects one of the regression models obtained by the regression model obtainer 3 based on the environmental information collected by the information collection 2. The state index calculator 5 calculates a state index value using the selected regression model selected by the regression model selector 4. This improves the accuracy in failure prediction as the regression model used for calculating a failure risk is selected according to the environmental information that affects a result of failure prediction determination.

Further, in this example, the regression models are generated using the logistics regression analysis, thus increasing the processing speed of generating the regression models as well as the accuracy of the regression models.

The internal information of the copier 10, which is used by the regression model obtainer 3 for generating the regression models, includes failure internal information of the copier 10 obtained when a failure occurs and normal internal information of the copier 10 obtained after such failure is fixed. Using the failure and normal internal information of the copier 10, which is easily obtained from log or history data of the copier 10, any one of the regression models may be easily generated.

In order to reflect the seasonal changes, any one of the regression models may be updated when the environmental information satisfies a predetermined condition, thus improving the accuracy in prediction a failure.

The regression models may be further categorized based on the cause of a failure. With the regression models that are determined based on the cause of a failure, the accuracy in predicting a failure improves.

In the above-described example, the failure prediction determiner 8 determines whether the apparatus is most likely to fail based on the failure risk calculated by the failure risk calculator 7.

In the above-described example, the failure prediction apparatus 1 stores a plurality of failure risk values that are previously calculated using the state index values and the usage factors that may be respectively calculated using the different regression models that are categorized based on environmental information, and a plurality of determination results generated based on the corresponding failure risk values. The failure prediction determiner 8 classifies the plurality of determination results by the failure risk values into a plurality of classes. The failure prediction determiner 8 selects one of the determination results that belongs to the class corresponding to the failure risk value currently obtained by the failure risk calculator 7. Based on the selected determination result, the failure risk determiner 8 is able to easily determine a state of the apparatus with the improved accuracy.

Further, a threshold value used for classifying the plurality of determination results of the failure risk determiner 8 may be changed so as to control a criterion for determining whether the apparatus has a failure risk state that is high.

When the selected determination result belongs to the class of the highest failure risk value, the failure prediction determiner 8 determines that the service engineer should be dispatched. By dispatching the service engineer to the location at which the copier 10 having a failure risk state of the highest degree is provided, the service engineer is able to maintain the copier 10 before any failure occurs.

Further, the determination result of the failure risk determiner 8 may be displayed on the display unit 9 or 25, thus allowing a user to view the determination result or any other information that may be useful for predicting a failure.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

What is claimed is:

1. A state determining apparatus for determining a state of an apparatus, the state determining apparatus comprising:
an information collection unit configured to collect internal information of the apparatus and usage information of the apparatus, the usage information indicating the degree of usage of the apparatus by a user of the apparatus;
a regression model acquisition unit configured to obtain a regression model;
a state index calculator unit configured to calculate a state index value of the apparatus using the regression model obtained by the regression model acquisition unit and the internal information of the apparatus collected by the information collection unit;
a computation formula data storage unit configured to store computational formula data;
a usage factor calculator unit configured to calculate a usage factor using the computation formula data stored in the computation formula data storage unit and the usage information of the apparatus collected by the information collection unit, the usage factor indicating a predicted remaining time period between a time when the state index value is calculated by the state index calculator unit and a time when a failure is most likely to occur in the apparatus;
a failure risk calculator unit configured to calculate a failure risk of the apparatus using the state index value calculated by the state index calculator unit and the usage factor calculated by the usage factor calculator unit; and
a failure prediction determiner unit configured to determine a failure risk state of the apparatus that indicates the probability for the apparatus to fail in the near future based on the failure risk calculated by the failure risk calculator unit to generate a determination result.

2. The state determining apparatus of claim 1, wherein the computational formula data is a conversion formula that converts an index value indicating the degree of change in the usage information over time into the usage factor.

3. The state determining apparatus of claim 2, wherein:
the information collection unit collects environmental information of the apparatus in addition to the internal information of the apparatus and the usage information of the apparatus, and
the regression model obtained by the regression model acquisition unit includes a plurality of regression models that are classified based on the environmental information,
the state determining apparatus further comprising:
a regression model selector configured to select one of the plurality of regression models obtained by the regression model acquisition unit based on the environmental information of the apparatus as a selected regression model, and cause the state index calculator unit to calculate the state index value using the selected regression model.

4. The state determining apparatus of claim 2, wherein the regression model acquisition unit generates the regression model using logistics regression analysis.

5. The state determining apparatus of claim 2, wherein:
the internal information of the apparatus includes failure state internal information of the apparatus obtained when the apparatus failed and normal state internal information of the apparatus obtained after the failure of the apparatus is fixed, and
the regression model acquisition unit obtains the regression model using the failure state internal information and the normal state internal information of the apparatus.

6. The state determining apparatus of claim 3, wherein the regression model acquisition unit updates the regression model when at least one of the internal information, the usage information, and the environmental information respectively collected by the information collection unit satisfies a predetermined condition.

7. The state determining apparatus of claim 3, wherein the regression model acquisition unit further classifies the plurality of regression models based on a specific cause of the failure.

8. The state determining apparatus of claim 2, wherein the failure prediction determiner unit is configured to:
classify a plurality of determination results previously generated by the failure prediction determiner unit into a plurality of classes of determination results based on failure risk values of the determination results; and
selects one of the plurality of classes of determination results that corresponds to the failure risk calculated by the failure risk calculator unit,
wherein the determination result generated based on the failure risk calculated by the failure risk calculator unit is the same as the determination result of the selected one of the plurality of classes of determination results.

9. The state determining apparatus of claim 8, further comprising:
a threshold controller configured to change a threshold used for classifying the plurality of determination results.

10. The state determining apparatus of claim 7, wherein the failure risk determiner unit determines that servicing is required when the selected one of the plurality of classes of determination results has maximum failure risk values.

11. The state determining apparatus of claim 1, further comprising:
a display unit configured to display the determination results.

12. The state determining apparatus of claim 1, wherein the information collection unit periodically collects at least the internal information and the usage information from the apparatus.

13. The state determining apparatus of claim 1, wherein the information collection unit further collects apparatus identification information identifying the apparatus, and collection date information specifying a date and time when the internal information and the usage information of the apparatus is collected, in addition to the internal information and the usage information.

14. A failure predicting system comprising:
the state determining apparatus of claim 1; and
an apparatus subjected to failure prediction determination by the state determination apparatus, wherein the state determining apparatus collects the internal information and the usage information of the apparatus through a network that connects the state determining apparatus and the apparatus.

15. The system of claim 14, wherein the apparatus is an image forming apparatus that forms an image on a recording sheet.

16. A method for determining a state of an apparatus, comprising:
collecting internal information of the apparatus and usage information of the apparatus;
obtaining a regression model;
calculating a state index value of the apparatus using the regression model and the internal information of the apparatus;
storing computational formula data in a computation formula data storage unit;
calculating a usage factor using the computation formula stored in the computation formula data storage unit and the usage information of the apparatus, the usage factor indicating a predicted remaining time period between a time when the state index value is calculated and a time when a failure is most likely to occur in the apparatus;
calculating a failure risk of the apparatus using the state index value and the usage factor; and
determining a failure risk state of the apparatus that indicates the probability for the apparatus to fail in the near future based on the failure risk to generate a determination result.
